(19) United States
(12) Patent Application Publication
(10) Pub. No.: US 2004/0069701 A1
(43) Pub. Date: Apr. 15, 2004

(54) Membrane filter

(76) Inventors: Simon Roelof Vasse, Hardenberg (NL); Albert Collin, Drachten (NL)

Correspondence Address: Richard L Byrne, 700 Koopers Building, 436 Seventh Avenue, Pittsburgh, PA, 15219-1818, US

(21) Appl. No.: 10/466,066

(22) PCT Filed: Nov. 30, 2001
(86) PCT No.: PCT/NL01/00868

(30) Foreign Application Priority Data
Jan. 9, 2001 (NL) 1017061

(51) Int. Cl. B01D 63/06

(52) U.S. Cl. 210/321.88; 210/321.79

(57) ABSTRACT

The invention relates to a membrane filter (1), comprising: an extruded tube (2) with a groove (13) arranged through deformation on at least one end: a number of elongate filter elements (4) extending in longitudinal direction; and a synthetic resin plug (5) which is arranged in the at least one end and through which the elongate filter elements (4) extend. The advantage of the invention is that the outer wall of the tube (2) is not damaged and retains its strength.

Known membrane filters with membrane filter capillaries consist of a PVC pipe sleeve in which the capillaries are encapsulated with a synthetic resin on both sides. At both ends this pipe sleeve is provided on the outside by means of glueing with a strengthening bush in which a peripheral groove is arranged by means of a machining operation. For discharge of the filtrate a further one or two additional bushes are moreover arranged on which the connections are provided. The drawback of such a membrane filter is the usually heavy construction, since extra material is required for the strengthening bush, and that a glueing operation and a machining operation have to be carried out, whereby the is cost of such a membrane filter is high.

It is an object of the present invention to obviate the above stated drawbacks. This object is achieved with a membrane filter according to the invention, comprising:

an extruded tube with a groove arranged through deformation on at least one end;

a number of elongate filter elements extending in longitudinal direction; and

a synthetic resin plug which is arranged in the at least one end and through which the elongate filter elements extend.

The advantage of such a membrane filter according to the invention is that the outer wall of the extruded tube is not damaged by machining operations, whereby the outer wall retains its full strength and glueing of turned or injection moulded parts is unnecessary. The synthetic resin plug could for example comprise polypropyleen. Another advantage of the membrane filter according to the invention is that the synthetic resin, also referred to as potting, arranged in the tube gives additional strength in both axial and radial direction in that the groove protrudes inward and the synthetic resin has formed around it. Another great advantage is that this membrane filter can be designed with a minimal material weight.

Extruded tube is readily available in diverse diameters at a relatively low price and in different pressure classes, while it provides sufficient strength to withstand the pressures. In addition, the length of an extrusion tube is unlimited in terms of the production process, with the result that membrane filters according to the invention can be manufactured to any desired length and at low cost.

In a preferred embodiment according to the invention the groove is arranged by heating and then deforming a tube end.

The groove can be formed such that it is suitable for a “victaulic” clamp connection which connects onto a manifold.

The groove can also be used as key way for a sleeve for sliding over the tube end.

In another embodiment of the membrane filter according to the invention the tube comprises a radially extending connecting opening. A pipe part can be arranged hereon. The tube wall can be deformed by heating the tube such that the opening with the tube end thereon can be formed integrally with the tube. Connections can thus be made to the tube in simple manner.

A membrane filter according to the invention can further comprise perforations arranged in the tube wall. Such an embodiment can be used in the case the filter is suspended in a basin and the medium for cleaning is sucked through the filter.

The tube of the membrane filter according to the invention can comprise polyvinyl chloride, polyethylene or polypropylene, or another thermoplastic.

The invention further comprises a method for manufacturing a membrane filter according to the invention, which method comprises the steps of:

extruding a tube;

heating an end of the extruded tube;

deforming the end such that a groove is formed in the end of the tube;

placing in the tube a number of elongate filter elements extending in longitudinal direction; and

casting synthetic resin in the at least one end to form a plug.

Applicant assumes that when axial and radial forces are exerted on the filter housing at the position of the groove, the potting arranged on the inside of the tube also functions as strengthening of the wall in both directions. In addition, it is assumed that during forming of the groove the wall is strengthened as a result of biaxial orientation.

These and other features of the invention are further elucidated with reference to the annexed drawings.

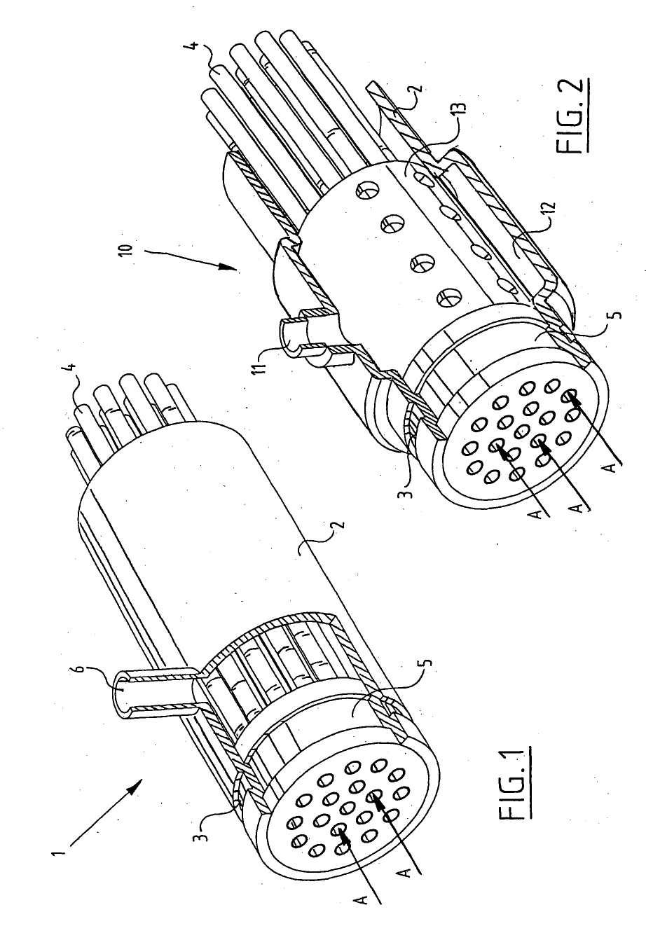

FIG. 1 shows a perspective view with partly broken-away parts of a first embodiment of a membrane filter according to the invention;

FIG. 2 shows a perspective view with partly broken-away parts of a second embodiment of a membrane filter according to the invention.

FIG. 1 shows a first embodiment of a membrane filter 1. This membrane filter 1 has an extruded tube 2 comprising on its end a groove 3 arranged by deformation. Arranged in tube 2 are elongate capillary tubes 4 which are encapsulated at the end in a synthetic resin plug 5. Medium for filtering will be supplied in the direction of arrow A to capillary tubes 4 and will then flow radially out of the tubes, and can subsequently flow out of tube 2 via the outlet opening 6 arranged thereon.

Because the synthetic resin plug 5 is cast on the inside around groove 3, it will impart extra strength to the end of tube 2 and to groove 3.

FIG. 2 shows a second embodiment of a membrane filter according to the invention. This filter 10 corresponds in large measure with the filter according to FIG. 1, and the same components are therefore designated with the same reference numerals.

At the position where the connection 11 is arranged along which the medium can flow away, a peripheral chamber 12 is formed in tube wall 2. This can be formed in a manner similar to groove 3. A perforated bush 13 is further placed around the capillary tubes 4 at the position of chamber 12. This bush has the function of protecting capillary tubes 4 when the membrane filter is cleaned. This cleaning takes place by a cleaning liquid being injected via opening 11 and then entering capillary tubes 4 in radial direction. The flow direction is opposed to the flow direction during normal use.

It is possible to embody groove 3 as a helical groove, whereby a connecting piece can be screwed onto the membrane filter. Before the filter elements are potted in the synthetic resin, the tube surface must be treated at this location so as to obtain a good adhesion. It is also possible to form a flange instead of groove 3 and to embody the coupling as for instance a “snap connection”. In this case there will be a bulge instead of a groove, although other mechanical couplings, such as a bayonet fitting, can also be formed in similar manner on a tube end. In addition, it is also possible that, instead of the capillary tubes 4 being potted in the housing, other embodiments of filter elements are encapsulated, for instance those of the “spirally wound” type.

A third embodiment (not shown) of a membrane filter according to the invention corresponds for the greater part with for instance the membrane filter 1 of FIG. 1. In this third embodiment the tube wall 2 is herein provided with a large number of perforations. Not only can medium hereby flow out or in via outlet opening 6, but also via the perforations. Membrane filters in accordance with this third embodiment are advantageous in the treatment of water. For this purpose these membrane filters are suspended in a basin of water for cleaning and the water for cleaning is drawn via the perforations into the filter through capillary tubes 4. The advantage of such an arrangement of the filter elements and suction of the medium for filtering is that lower pressures can be used, whereby capillary tubes 4 will become contaminated less rapidly.

1. Membrane filter, comprising:
an extruded tube with a groove arranged through deformation on at least one end;
a number of elongate filter elements extending in longitudinal direction; and
a synthetic resin plug which is arranged in the at least one end and through which the elongate filter elements extend.

2. Membrane filter as claimed in claim 1, wherein the groove is arranged by heating and then deforming the tube end.

3. Membrane filter as claimed in either of the foregoing claims, wherein the tube comprises a radially extending connecting opening.

4. Membrane filter as claimed in claim 3, wherein a pipe part is arranged on the connecting opening.

5. Membrane filter as claimed in any of the foregoing claims, wherein perforations are arranged in the tube wall.

6. Membrane filter as claimed in any of the foregoing claims, wherein at least the tube comprises polyvinyl chloride, polyethylene, polypropylene or another thermoplastic.

7. Method for manufacturing a membrane filter as claimed in any of the foregoing claims, which method comprises the steps of:
extruding a tube;
heating an end of the extruded tube;
deforming the end such that a groove is formed in the end of the tube;
placing in the tube a number of elongate filter elements extending in longitudinal direction; and
casting synthetic resin in the at least one end to form a plug.
